(19) United States
(12) Patent Application Publication
(10) Pub. No.: US 2014/0379607 A1
(43) Pub. Date: Dec. 25, 2014

(54) DELIVERY MANAGEMENT APPARATUS AND RECORDING MEDIUM

(71) Applicant: YAHOO JAPAN CORPORATION, Tokyo (JP)

(72) Inventors: Yuushi CHOUSA, Tokyo (JP); Yutaka HYODO, Tokyo (JP)

(21) Appl. No.: 14/300,486

(22) Filed: Jun. 10, 2014

(30) Foreign Application Priority Data
Jun. 19, 2013 (JP) 2013-128822

(51) Int. Cl. G06Q 10/08

(52) U.S. Cl. CPC G06Q 10/0836
USPC 705/339

(57) ABSTRACT

A delivery management apparatus includes a delivery information reception unit that receives from a sender information about a shipping deposit location relating to a delivery item, and receives from a recipient information about a receipt location relating to the delivery item; a delivery person determination unit that communicates at least the information about the shipping deposit location and the information about the receipt location to users in order to recruit a user desiring to perform delivery, and determines a delivery person from applicant users; and a delivery procedure communication unit that at least communicates to the delivery person information used for pickup of the delivery item from the shipping deposit location or from a relay storage location and information used for storage in the relay storage location or in the receipt location, and communicates to the recipient information used for pickup of the delivery item from the receipt location.

### CROSS-REFERENCE TO RELATED APPLICATIONS

The present invention contains subject matter related to Japanese Patent Application No. 2013-128822 filed in the Japan Patent Office on Jun. 19, 2013, the entire contents of which are incorporated herein by reference.

### BACKGROUND OF THE INVENTION

1. Field of the Invention

The present invention relates to a delivery management apparatus and a recording medium.

2. Description of the Related Art

In recent years, as lifestyles have changed and people have been unable to always be at home in order to receive a delivery item delivered to their homes, services that use lockers have been proposed, for example, as one of services that enable effective receipt of delivery items. In such services, a locker system is used in which a user is able to receive an item that the user has ordered by phone, via the Internet, or the like in such a way that the item is delivered by a delivery service provider to a locker specified by the user (see Japanese Unexamined Patent Application Publication No. 2007-84273, for example).

A locker system has been available in which a delivery service provider forwards a package that a user has deposited in a locker to a locker located in a place that the user desires (see Japanese Unexamined Patent Application Publication No. 2008-123055, for example).

It is considered that, with the locker systems described in Japanese Unexamined Patent Application Publication No. 2007-84273 and Japanese Unexamined Patent Application Publication No. 2008-123055, a user is able to receive a delivery item from a desired locker on any day and at any time the user likes.

However, in the locker systems according to Japanese Unexamined Patent Application Publication No. 2007-84273 and Japanese Unexamined Patent Application Publication No. 2008-123055, typical delivery service providers handle delivery. Therefore, delivery costs are incurred and furthermore the facility costs of the systems involved are huge. Recently, a price war has started so as to minimize the delivery costs, however, the delivery costs depend on distance and size regardless of the unit price and therefore cannot be eliminated, to be exact.

### SUMMARY OF THE INVENTION

According to an embodiment of the present invention, there is provided a delivery management apparatus including a delivery information reception unit, a delivery person determination unit, and a delivery procedure communication unit. The delivery information reception unit receives from a sender input of information about a shipping deposit location relating to a delivery item, and receives from a recipient input of information about a receipt location relating to the delivery item. The delivery person determination unit communicates at least the information about the shipping deposit location and the information about the receipt location to users in order to recruit a user who desires to perform delivery, and determines a delivery person from applicant users in accordance with a predetermined rule. The delivery procedure communication unit at least communicates to the delivery person information used for pickup of the delivery item from the shipping deposit location or from a relay storage location in which another delivery person has stored the delivery item and information used for storage in the relay storage location or in the receipt location, and communicates to the recipient information used for pickup of the delivery item from the receipt location in which the delivery person has stored the delivery item.

### BRIEF DESCRIPTION OF THE DRAWINGS

FIG. 1 is a diagram illustrating an example of a configuration of a system according to an embodiment of the present invention;

FIGS. 2A to 2D are diagrams illustrating examples of data structures of various databases (DBs);

FIG. 3 is a diagram illustrating an example of a delivery route in an embodiment of the present invention;

FIG. 4 is a diagram illustrating an example of a different delivery procedure in an embodiment of the present invention;

FIG. 5 is a diagram illustrating an example of a delivery management sequence according to an embodiment of the present invention; and

FIG. 6 is a diagram illustrating an example of a different delivery route in an embodiment of the present invention.

### DETAILED DESCRIPTION OF THE PREFERRED EMBODIMENTS

Hereinafter, an embodiment of the present invention will be described with reference to the drawings.

In an embodiment of the present invention, an auction item for which a transaction has been completed between a seller S and a bidder R particularly at an online auction is delivered by another user to a location that the bidder R desires.

Particularly, as a storage location of an auction item, train station lockers are used, and another user delivers the auction item between specified train station lockers to thereby preferably implement an embodiment. Accordingly, in an embodiment, a sender of an item is referred to as a seller S and a recipient of an item is referred to as a bidder R. A delivery item is also referred to as an auction item.

System Configuration

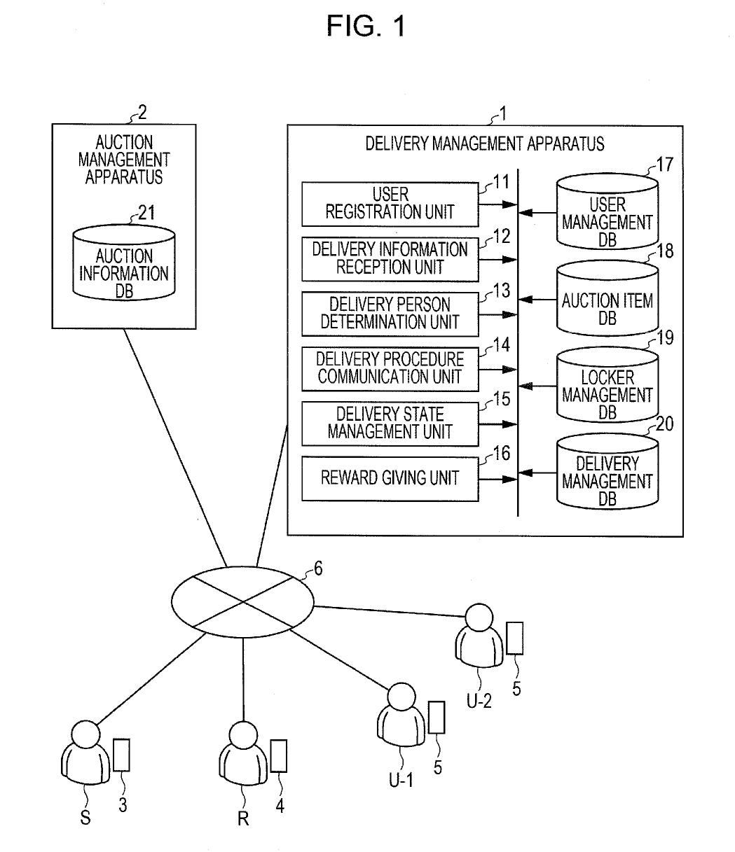

Before describing the specific details of the embodiment of the present invention, a system configuration used to implement the embodiment will be described first. FIG. 1 is a diagram illustrating a network configuration according to the embodiment in which a delivery management apparatus 1, an auction management apparatus 2, and user terminals 3, 4, and 5 are connected to one another over a network 6.

In this specification, the user terminal 3 is a user terminal of a seller S who participates in an auction, the user terminal 4 is a user terminal of a bidder R who participates in an auction, and the user terminals 5 are user terminals of other general users U-1 and U-2 (hereinafter also individually referred to as a general user U or collectively referred to as general users U).

The delivery management apparatus 1 is a server that manages delivery in the embodiment, and provides a delivery management service for an auction item for which a transaction has been completed at an auction, by using information in an auction information DB 21 constituted by online auction content provided by the auction management apparatus 2.

The delivery management apparatus 1 includes functional units, namely, a user registration unit 11, a delivery information reception unit 12, a delivery person determination unit 13, a delivery procedure communication unit 14, a delivery state management unit 15, and a reward giving unit 16.

The delivery management apparatus 1 includes various DBs, namely, a user management DB 17, an auction item DB 18, a locker management DB 19, and a delivery management DB 20.

In the case where a mechanism is separately provided in which an operator of the delivery management apparatus 1 manages user information in an integrated manner, the user registration unit 11 and the user management DB 17 may be omitted by using such a mechanism.

The user registration unit 11 has a function of issuing a user identifier (ID) in response to a request made via a browser of the user terminal 5 of the general user U who has not completed user registration and registering the user in the user management DB 17.

Prior to using an online auction, in response to a request made via a browser of the user terminal 3 of the seller S and in response to a request made via a browser of the user terminal 4 of the bidder R, the seller S and the bidder R have been registered as users in the auction information DB 21 of the auction management apparatus 2. The user registration unit 11 also has a function of registering in the user management DB 17 user registration information stored in the auction information DB 21 to thereby store registration information on all users.

The delivery information reception unit 12 receives input of shipping deposit location information relating to an auction item from the user terminal 3 of the seller S. The delivery information reception unit 12 also receives input of receipt location information relating to the auction item from the user terminal 4 of the bidder R. The delivery information reception unit 12 has a function of registering the shipping deposit location information and receipt location information that have been received in the user management DB 17 and in the auction item DB 18.

The delivery information reception unit 12 also has a function of receiving information about an auction item from the user terminal 3 and registering the information in the auction item DB 18. Information about an auction item is information about the “size (length and width)”, “weight”, and the like of an auction item, for example. The auction item ID, product name, and the like of an auction item have already been stored in the auction item DB 18 by referring to the user IDs of the seller S and the bidder R stored in the auction information DB 21 described above.

The delivery person determination unit 13 displays information about an auction item, shipping deposit location information, and receipt location information in content provided by the delivery management apparatus 1, and recruits a delivery person who desires to deliver the auction item from among users. The delivery person determination unit 13 has a function of determining a delivery person from among applicant users on the basis of a predetermined rule and registering the determined delivery person in the delivery management DB 20.

More specifically, the delivery person determination unit 13 displays shipping deposit location information and receipt location information relating to an auction item on the user terminals 5 of the general users U, who are not the seller S nor the bidder R and who have been registered by the auction management apparatus 2 and the user registration unit 11, and recruits a general user U as a delivery person U. The delivery person determination unit 13 particularly has a function of determining a delivery person U from among applicant users who have completed user registration, in accordance with a predetermined rule.

A predetermined rule is such that, on the basis of input of information from the user terminals 5 of the applicant users made in response to the recruitment, the information including stations covered by the commuter pass of each applicant user, the sex and age of each applicant user, and stations to which delivery is possible, an appropriate delivery person is determined by matching information recorded in the auction item DB 18, such as the size, weight, shipping deposit location, receipt location, and the like of the auction item, with the inputted information. In this case, the number of delivery persons to be determined is not necessarily one, and processing may be performed in which a plurality of delivery persons deliver an auction item to the receipt location of the bidder R via a relay storage location (hereinafter also referred to as a relay locker).

The delivery procedure communication unit 14 has a function of communicating, to each of the user terminal 3 of the seller S, the user terminal 5 of the general user U who is a delivery person, and the user terminal 4 of the bidder R, a procedure to be performed in order to deliver an auction item from the shipping deposit location to the receipt location, and recording the communicated information in the delivery management DB 20.

The delivery procedure communication unit 14 communicates to the user terminal 3 of the seller S information used for storage in the shipping deposit location.

In the embodiment, a station near the seller S has been registered as the shipping deposit location. Therefore, the delivery procedure communication unit 14 communicates to the seller S the auction item ID (also referred to as the package ID) and the name of the station near the seller S to make the seller S start delivery. In the case where a shipping locker has been specified in advance as a shipping deposit location on the basis of locker information registered in the locker management DB 19, the shipping locker number, information about locking of the locker, and information about unlocking of the locker are also communicated to the user terminal 3 of the seller S.

Information used for pickup of the auction item from the shipping deposit location (shipping locker) or from the relay storage location and information used for storage in the relay storage location or in the receipt location are communicated to the user terminal 5 of the delivery person U. The relay storage location is a location where, in the case where a plurality of delivery persons handle delivery of a package, the package is relayed between two persons. Specifically, the relay storage location is the name of a station that is a contact point of two persons. In the case where a relay locker has been specified as a relay storage location in which a package is to be stored as described above, the relay storage location is called a relay locker. In the case of referring to a relay storage location after storage in a locker, the relay storage location is also called a relay locker.

Accordingly, to be exact, information used for pickup from the shipping locker and from the relay locker, the relay storage location (station), information used for storage in the relay locker, and information used for storage in the receipt locker are communicated to the delivery person U.

The information used for pickup includes the name of a station where the auction item is stored, the shipping locker number, the relay locker number, information about locking of the lockers, information about unlocking of the lockers, and the auction item ID, for example, which have been communicated from the seller S or the delivery person U.

The information used for storage includes at least the name of a station where the auction item is to be stored next and the auction item ID. In the case where a locker (a relay locker or a receipt locker) in which the auction item is to be stored next has been specified, information, such as the relay locker number or the receipt locker number, information about locking of the locker and information about unlocking of the locker, and the like, are also communicated.

Information used for pickup from the receipt locker is communicated to the user terminal 4 of the bidder R. Here, the information used for pickup includes the name of a station specified by the bidder R, the locker number of a locker in which the auction item has been stored by a last delivery person U, information about locking of the locker and information about unlocking of the locker, the auction item ID, and the like.

As described above, information communicated to a user terminal differs depending on whether or not a specific locker is able to be specified, and appropriate information is communicated as needed.

The delivery state management unit 15 has a function of receiving information about the storage state and the pickup state of the auction item from the user terminal 3 of the seller S, the user terminal 5 of the delivery person U, and the user terminal 4 of the bidder R, and recording the information in the delivery management DB 20.

That is, the delivery state management unit 15 prompts the user terminal 3 of the seller S to send a notification of completion of storage in the shipping locker, and receives a storage completion notification at the time of completion of storage in the shipping locker.

The delivery state management unit 15 prompts the user terminal 5 of the delivery person U to send a notification of completion of pickup from the shipping locker or from the relay locker, and receives a pickup completion notification at the time of completion of pickup from the shipping locker or from the relay locker. The delivery state management unit 15 also prompts the user terminal 5 of the delivery person U to send a notification of completion of storage in the relay locker or in the receipt locker, and receives a storage completion notification at the time of completion of storage.

The delivery state management unit 15 prompts the user terminal 4 of the bidder R to send a notification of completion of pickup from the receipt locker, and receives a pickup completion notification at the time of completion of receipt of the auction item from the receipt locker.

Note that, when the delivery state management unit 15 receives a storage completion notification described above, the delivery procedure communication unit 14 notifies the user terminal of a person next involved the completion of storage, and communicates to the user terminal of the person next involved information used for pickup from the locker in which the auction item has been stored.

The information used for pickup includes the name of the station, the locker number, information about locking of the locker and information about unlocking of the locker, the auction item ID, and the like as described above.

Furthermore, when the delivery state management unit 15 receives from each user terminal a notification of completion of storage in a locker concerned or a notification of completion of pickup from a locker concerned, the delivery state management unit 15 links communicated information with the date and time, and records and stores the information in the delivery management DB 20.

The delivery state management unit 15 also has a function of displaying information on each user terminal concerned such that the information is browsable, the information including information about storage in the shipping locker by the seller S, information about completion of pickup from the shipping locker or from the relay locker by the delivery person U, information about completion of storage in each locker described above, and information about completion of pickup from the receipt locker by the bidder R.

The reward giving unit 16 has a function of giving a bonus to the delivery person U who has delivered the auction item after receiving from the bidder R a notification of completion of pickup of the auction item.

Note that, in the delivery management apparatus 1 described above, information communicated by the delivery procedure communication unit 14 differs depending on the infrastructure, such as the locker apparatuses or the user terminals. Basically, information used for storage of an auction item and information used for pickup of an auction item are communicated as appropriate.

The above-described functional units of the delivery management apparatus 1 are implemented by a computer program that runs on hardware resources, such as a central processing unit (CPU), a read-only memory (ROM), and a random access memory (RAM), of a computer that constitutes the delivery management apparatus 1. The functional units need not be placed in a single computer and may be distributed as appropriate.

The above-described DBs are used to systematically retain data on a recording medium, such as a hard disk drive (HDD) of the delivery management apparatus 1.

The auction management apparatus 2 is a content server that provides an online auction service, and provides online auction content to the user terminals 3 and 4. In the above-described auction information DB 21, information about users, such as user IDs of users who use the online auction service, and information relating to auctions, such as information about items on sale, specifically, information about placement of items, information about bidding, and the like, are stored.

The user terminals 3 to 5 are client terminals used to browse web content including advertisements. Each of the user terminals 3 to 5 is constituted by an information processing device, such as a personal computer (PC), a personal digital assistant (PDA), or a portable phone, for example, and has a web browser (web content browsing software) and a mailer. In the embodiment, each of the user terminals 3 to 5 may be a portable terminal including an infrared communication device having a dedicated utility program mounted therein and used for communication with the delivery management apparatus 1.

The network 6 may be a wired or wireless network, and may be the Internet, for example.

Note that FIG. 1 is merely an example of the configuration given in order to describe an embodiment of the present invention. The delivery management apparatus 1 may be configured in the same server that serves as the auction management apparatus 2. The internal functional units and the DBs, which will be described below, may be configured in a different server and this server may be placed in (or connected to) the network 6.

DBs

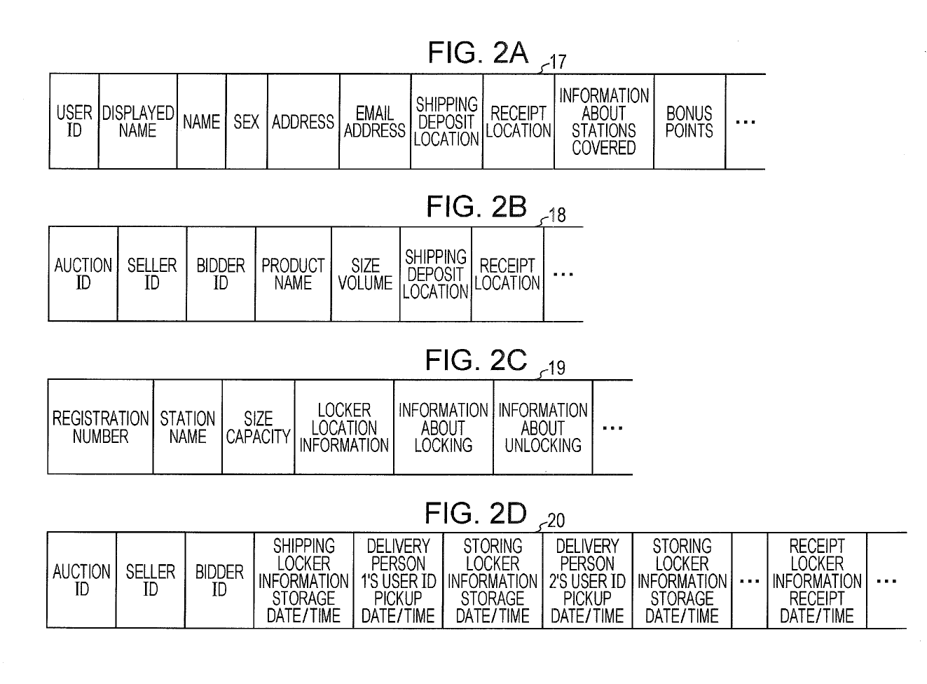

FIGS. 2A to 2D are diagrams illustrating examples of data structures of various DBs.

FIG. 2A illustrates the data structure of the user management DB 17, which includes data items, such as “user ID”, “displayed name”, “name”, “sex”, “address”, “email address”, “shipping deposit location”, “receipt location”, “information about stations covered”, “bonus points”, and the like.

The “user ID” is an ID used to identify a service user, such as the seller S, the bidder R, or the delivery person U.

The “displayed name” is a name of a service user which is displayed on a page screen, like “Seller S”, “Bidder R”, or “Delivery Person U”.

The “name” is the name of a service user. The “sex” is the sex of a service user, which is a data item particularly referred to in the case of determination of a delivery person U.

The “address” is the address of a service user. The “email address” is an email address of a service user. The “shipping deposit location” is a specific location to which the seller S wants to ship a registered auction item. In the embodiment, an example of the “shipping deposit location” is the name of a station near the seller S.

The “receipt location” is a specific location from which the bidder R wants to receive the registered auction item. In the embodiment, an example of the “receipt location” is the name of a station near the bidder R.

The “information about stations covered” is information about the stations at which a service user usually gets on and off, and an example of information registered as the “information about stations covered” is “Shibuya station—Tokyo station”. This information is also referred to in the case of determination of a delivery person U. Note that, in the user management DB 17, all or part of the information registered in the auction information DB 21 of the auction management apparatus 2 described above is registered.

As the “bonus points”, points given to an auction user by the auction management apparatus 2 are registered, which may be used in services such as an auction. Note that, in the embodiment, a bonus given to a delivery person as a reward is added to the “bonus points” as appropriate.

FIG. 2B illustrates the data structure of the auction item DB 18, which includes data items, such as “auction ID”, “seller ID”, “bidder ID”, “product name”, “size and volume”, “shipping deposit location”, “receipt location”, and the like.

The “auction ID” is an ID automatically given to an auction that has been started.

The “seller ID” is an ID used to identify the seller S who has put an item up for auction. The “bidder ID” is an ID used to identify the bidder R who has made a successful bid for the item at the auction.

The “product name” is the name of an item put for auction. The “size and volume” is information, such as the “length and width”, “weight”, and the like of the item.

The “shipping deposit location” is a specific location to which the seller S wants to ship a registered auction item as described above. The “receipt location” is a specific location from which the bidder R wants to receive the registered auction item.

FIG. 2C illustrates the data structure of the locker management DB 19, which includes data items, such as “registration number”, “station name”, “size and capacity”, “locker location information”, “information about locking”, “information about unlocking”, and the like.

The “registration number” is an ID used to identify information about each locker which is stored in the locker management DB 19. The “station name” is station name information used to identify a station in which the corresponding locker is located. In the case of a big station, supplemental information, such as “west gate” or “east gate”, is particularly added.

As the “size and capacity”, information, such as the length and width, capacity, and the like of the corresponding locker, is registered.

The “locker location information” is detailed location information used to identify a specific locker, and may include a map or a locker layout map as appropriate.

As the “information about locking”, information used to lock a specific locker is registered. As the “information about unlocking”, information used to unlock a specific locker is registered. Such information about locking or unlocking differs depending on the type of the locker apparatus. For example, in the case of a dial-lock-type locker apparatus, the information is a dial number, and in the case of a locker apparatus locked by inputting a password number, the information is a password number. In the case of locking using electronic communication, the information is electronic information used for locking and unlocking which is inputted in an authentication barcode, in an authentication QR code (registered trademark), or in a portable terminal, for example.

The information about a locker described above includes information that is registered on the basis of information communicated from the seller S or the delivery person U and information that is stored in advance as locker information. Particularly, as the latter information, the “size and capacity” is registered in advance, which is helpful when the delivery procedure communication unit 14 communicates to a user terminal, on the basis of the locker management DB 19, the locker number, information about locking, information about unlocking, and the like of a locker in which the auction item is to be stored.

In the embodiment, deposit and pickup during delivery of an auction item are performed between specific lockers. In the case where delivery is performed between convenience stores located near the respective users, for example, a convenience store management DB is provided in which information used for identifying a convenience store, information used for receiving or depositing an auction item, and the like are stored.

Accordingly, the contents of the DB differ depending on what is used as a shipping deposit location or a receipt location.

FIG. 2D illustrates the data structure of the delivery management DB 20. The delivery management DB 20 includes information used for managing delivery, and particularly records and stores delivery log data. This DB includes data items, such as “auction ID”, “seller ID”, “bidder ID”, “shipping locker information and storage date/time”, “delivery person 1's user ID and pickup date/time”, the first “storing locker information and storage date/time”, “delivery person 2's user ID and pickup date/time”, the second “storing locker information and storage date/time”, . . . , “receipt locker information and receipt date/time”, and the like, for example.

The “auction ID” is an ID automatically given to an auction that has been started. The “seller ID” is an ID used to identify the seller S who has put an item up for auction. The “bidder ID” is an ID used to identify the bidder R who has made a successful bid for the item at the auction.

As the “shipping locker information and storage date/time”, the registration number of the shipping locker in which the seller S has stored the auction item and the date/time when the seller S stored the auction item are registered.

Regarding the “delivery person 1's user ID and pickup date/time”, the former “delivery person 1's user ID” is an ID used to identify a delivery person 1. As the latter “pickup date/time”, the date/time when the delivery person 1 picked up the auction item from the shipping locker is registered. As the first “storing locker information and storage date/time”, information about a storing locker in which the delivery person 1 has stored the auction item next, such as the relay locker number, add the date/time when the delivery person 1 stored the auction item are stored.

Regarding the “delivery person 2's user ID and pickup date/time”, the former “delivery person 2's user ID” is an ID used to identify a delivery person 2. As the latter “pickup date/time”, the date/time when the delivery person 2 picked up the auction item from the relay locker is registered. As the second “storing locker information and storage date/time”, information about a storing locker in which the delivery person 2 has stored the auction item next, such as the receipt locker number, and the date/time when the delivery person 2 stored the auction item are stored.

The “delivery person's user ID (namely, delivery person 1 (or 2)'s user ID described above) and pickup date/time” and “storing locker information and storage date/time” are repeatedly registered for the number of delivery persons handling delivery of the auction item.

As the “receipt locker information and receipt date/time”, the locker number of a receipt locker from which the bidder R has picked up the auction item and the date/time when the bidder R received the auction item are registered.

Delivery Procedure

Next, the overview of a delivery procedure in the embodiment which uses train station lockers will be described.

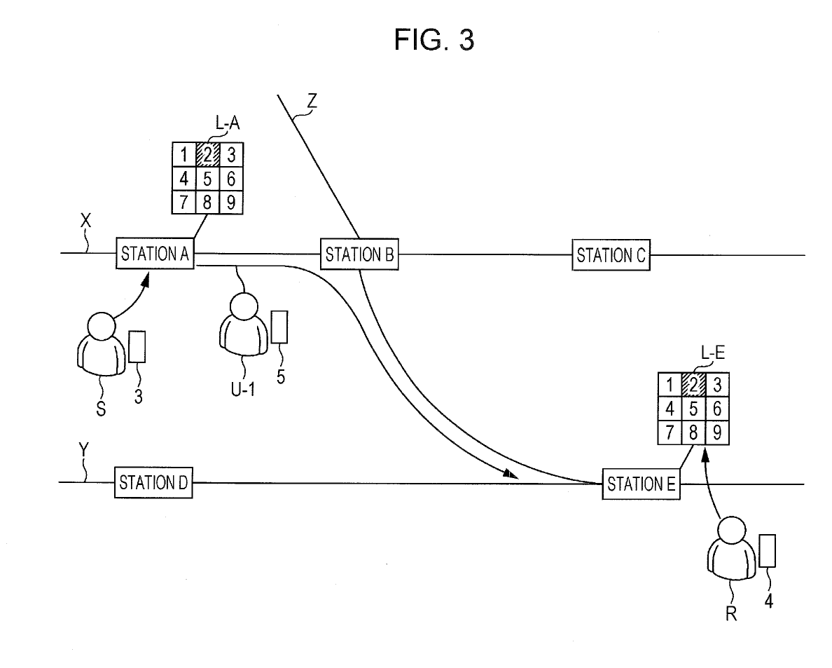

FIG. 3 is a diagram illustrating a delivery route in the embodiment of the present invention.

First, FIG. 3 illustrates a case where the seller S specifies a station A that is a station on a line X as a station at which the seller S ships an auction item (hereinafter also simply referred to as an item), and the bidder R specifies a station E that is a station on a line Y as a station at which the bidder R receives the item. An example of a case will be described in which, a line Z that connects a station B that is a station on the line X and the station E on the line Y exists between the station A and the station E. A case where one delivery person handles delivery will be described first.

The seller S stores an item in a shipping locker L-A-2 located in the station A specified by the seller S. A delivery person U-1 is a user who travels at least the route between the station A and the station B on the line X and the route between the station B and the station E on the line Z for commuting or the like. The delivery person U-1 picks up the item from the shipping locker L-A-2 and delivers the item from the station A to the station E, which is the station specified by the bidder R. Thereafter, the delivery person U-1 stores the delivered item in a receipt locker L-E-2 in the station E. The bidder R comes to the station E upon receiving a notification, and picks up and receives the item from the receipt locker L-E-2.

Next, a delivery procedure performed by two delivery persons will be described.

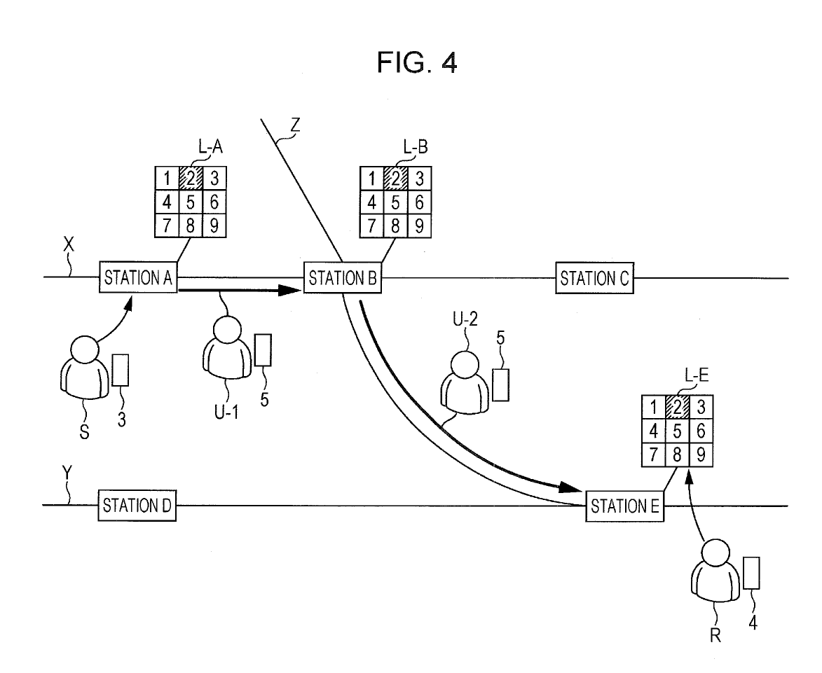

FIG. 4 is a diagram illustrating an example of a different delivery procedure in the embodiment. The delivery route in FIG. 4 is the same as that in FIG. 3, and a case where delivery is performed from the station A on the line X to the station E on the line Y is illustrated in FIG. 4.

The seller S stores an item in the shipping locker L-A-2 located in the station A specified by the seller S. The first delivery person U-1 is a user who travels at least the route between the station A and the station B on the line X. A second delivery person U-2 is a user who travels at least the route between the station B and the station E on the line Z. The contact point of the delivery person U-1 and the delivery person U-2 is the station B. Accordingly, in this case, a locker located in the station B that is the contact point of the two delivery persons is used as a relay locker and handover of the package is performed.

That is, the delivery person U-1 picks up the item from the shipping locker L-A-2 located in the station A, delivers the item from the station A to the station B, and stores the item in a relay locker L-B-2 located in the station B. The delivery person U-2 picks up the item from the relay locker L-B-2 in the station B, delivers the item from the station B to the station E, which is the station specified by the bidder R, and stores the delivered item in the receipt locker L-E-2 in the station E. The bidder R comes to the station E upon receiving a notification, and picks up and receives the item from the receipt locker L-E-2.

The overall configuration of the delivery management apparatus 1 and the overview of the delivery procedure according to the embodiment of the present invention have been described. Hereinafter, operations (processing) performed by the delivery management apparatus 1 will be described while assuming the above-described configuration.

Operations: Delivery Sequence Where Delivery of Auction Item Is Performed by A Plurality of Delivery Persons

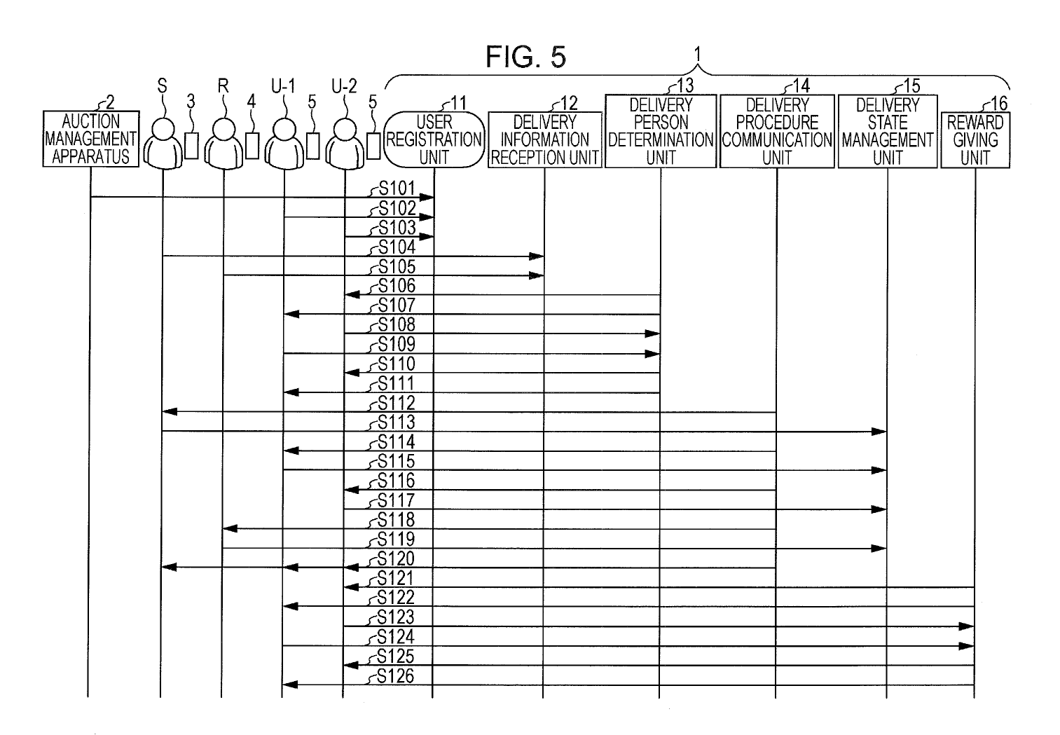

FIG. 5 is a diagram illustrating a delivery sequence performed by the system in the case where an item is delivered by a plurality of delivery persons as illustrated in FIG. 4. The delivery sequence in the case where an item is delivered by a single delivery person as illustrated in FIG. 3 is simple and description thereof overlaps description of the delivery sequence in FIG. 4. Therefore, description of the delivery sequence in FIG. 3 will be omitted.

The delivery management apparatus 1 of the embodiment performs delivery management, which is performed after a transaction has been completed at an auction between the seller S and the bidder R in the auction management apparatus 2. Hereinafter, a processing sequence to be performed after successful bidding will be described.

A description will be given while assuming a coin-operated locker usually used as a locker apparatus, which is a locker used by inputting a password number without using a key. A description will be given while assuming portable phones, such as smartphones, as the user terminals 3 to 5. Information is exchanged between the delivery management apparatus 1 and portable terminals of users over the network 6 by using email, a dedicated utility program, or dedicated content. As a matter of course, the embodiment is not limited to this case.

When an auction has been closed between the seller S and the bidder R, the auction management apparatus 2 makes the user registration unit 11 of the delivery management apparatus 1 register auction information recorded and stored in the auction information DB 21 (S101). The auction management apparatus 2 issues to other users who have not completed user registration user IDs in response to requests made via browsers of the user terminals 5 to thereby perform new user registration (S102 and S103). This user registration is particularly performed for a user who does not participate in the online auction, but the user registration is not limited to this case.

The delivery information reception unit 12 receives input of shipping deposit location information relating to an auction item from the user terminal 3 of the seller S (S104), and stores the shipping deposit location information in the user management DB 17 and in the auction item DB 18. In this case, the delivery information reception unit 12 also receives information about the auction item, such as the “length and width”, “weight”, and the like of the auction item, in addition to the shipping deposit location information, and stores the information in the auction item DB 18.

The delivery information reception unit 12 receives input of receipt location information relating to the auction item from the user terminal 4 of the bidder R (S105), and stores the receipt location information in the user management DB 17 and in the auction item DB 18. In the embodiment, as the shipping deposit location information relating to the seller S and the receipt location information relating to the bidder R, the names of stations located near the seller S and the bidder R respectively are inputted. Here, as shipping deposit location information and receipt location information, information registered in advance as near stations in the user information on the seller S and the bidder R may be inputted.

The delivery person determination unit 13 communicates to the user terminals 5 of other general users U-1 and U-2 who have completed user registration, the information about the auction item, the shipping deposit location information, and the receipt location information (S106 and S107), and recruits a delivery person who desires to perform delivery. In the delivery sequence illustrated in FIG. 5, the above-described information is communicated to the user terminals 5 of the registered general users U-1 and U-2 who desire to perform delivery, however, as a matter of course, such information is also communicated to the user terminals 5 of other users who have been registered in the auction management apparatus 2. The information about the auction item to be displayed here is information, such as the “size and volume” of the auction item, for example.

Here, the delivery person determination unit 13 may be configured to receive a search query from the user terminal 5, search for a delivery item corresponding to the search query, and communicate an item information list obtained as a result of the search.

When the delivery person determination unit 13 receives, from the user terminals 5 of the general users U-1 and U-2, requests for application relating to an item that the general users U-1 and U-2 are able to deliver, the item having been selected from the item information list (S108 and S109), the delivery person determination unit 13 determines the general users U-1 and U-2 to be delivery persons from among selected applicant users on the basis of a predetermined rule, and notifies the general users U-1 and U-2 of the determination (S110 and S111).

At the time of application in S108 and S109, the delivery person determination unit 13 acquires information about the users, such as “sex”, “information about stations covered”, or “information about stations to which delivery is possible”, from the user terminals 5 of the general users U-1 and U-2. Then, the delivery person determination unit 13 determines a delivery person by selecting a user from among applicant users who are able to deliver the item from the shipping deposit location (station A) to the receipt location (station B), by means of matching or the like. In this case, the delivery person determination unit 13 determines an appropriate delivery person by also taking into consideration the product name and weight of the auction item and the sex of the user.

In the embodiment, the two users, namely, the general user U-1 who travels from the station A to the station B and the general user U-2 who travels from the station B to the station E, are determined to be delivery persons, and the user terminals 5 are notified of the determination.

As described above, a delivery person is determined by recruitment from users who have completed user registration and therefore it is possible to build a distribution system in which a specialized delivery service provider is not requested to handle delivery. Delivery is performed by a user within an area between the stations to which the user usually travels and therefore additional costs will not be incurred. Furthermore, a user uses a day and time spent commuting to/from work, school, or the like and therefore the user does not need to use a specific day and time to perform the delivery, which is effective. Accordingly, in such a distribution system, it is possible to minimize delivery costs. In some cases, it is possible to reduce the delivery costs to substantially zero, which is sufficiently competitive with a mail delivery service provider that has realized low delivery costs.

When the notification has been sent to the delivery persons, the delivery procedure communication unit 14 communicates to the user terminal 3 of the seller S an instruction in order to make the seller S store the auction item in any shipping locker located in a near station registered in advance to thereby start delivery (S112). In this case, if a shipping locker has already been determined, the locker number of the shipping locker, information about locking, and information about unlocking are also communicated. Information about locking and information about unlocking mentioned in the delivery sequence are password numbers.

When the delivery state management unit 15 receives from the user terminal 3 of the seller S the user ID, information about the shipping locker (L-A-2) in which the auction item has been stored, and a storage completion notification (S113), the delivery state management unit 15 stores the user ID, the shipping locker information, and the storage date/time in the delivery management DB 20 as storage completion information.

The shipping locker information is basically the locker number of a shipping locker, however, the shipping locker information includes information about locking and information about unlocking. The shipping locker information is stored in the locker management DB 19.

When the storage completion information relating to storage in the shipping locker has been registered, the delivery procedure communication unit 14 communicates to the user terminal 5 of the delivery person U-1 information used for pickup of the auction item from the shipping locker (S114).

In S114, the delivery procedure communication unit 14 also communicates to the user terminal 5 of the delivery person U-1 information used in order to make the delivery person U-1 store the auction item in the relay locker located in the station B. In this case, the delivery procedure communication unit 14 may communicate information by specifying a locker located in the statin B in which the auction item is to be stored. The information used for pickup includes the name of the station, the shipping locker number, and the information about locking and information about unlocking that have been communicated by the seller S.

When the delivery state management unit 15 has received from the user terminal 5 of the delivery person U-1 a notification of completion of pickup of the auction item from the shipping locker (L-A-2) (S115), the delivery state management unit 15 stores the user ID, the shipping locker number, and the pickup date/time in the delivery management DB 20 as pickup completion information. In S115, when the delivery state management unit 15 has received from the user terminal 5 of the delivery person U-1 a notification of completion of storage in the relay locker (L-B-2) in the station B, the delivery state management unit 15 stores the user ID, the relay locker number, and the storage date/time in the delivery management DB 20 as storage completion information.

When the storage completion information has been stored, the delivery procedure communication unit 14 sends to the user terminal 5 of the delivery person U-2 a notification of completion of storage in the relay locker, and communicates to the user terminal 5 of the delivery person U-2 information used for pickup of the auction item from the relay locker (S116). In S116, the delivery procedure communication unit 14 also communicates to the user terminal 5 of the delivery person U-2 information used in order to make the delivery person U-2 store the auction item in the receipt locker located in the station E. The information used for pickup and the information used for storage each include the name of the station, the locker number, information about locking, information about unlocking, and the like.

When the delivery state management unit 15 has received from the user terminal 5 of the delivery person U-2 a notification of completion of pickup of the auction item from the relay locker (L-B-2) (S117), the delivery state management unit 15 stores the user ID, the relay locker number, and the pickup date/time in the delivery management DB 20 as pickup completion information. In S117, when the delivery state management unit 15 has received from the user terminal 5 of the delivery person U-2 a notification of completion of storage in the receipt locker (L-E-2), the delivery state management unit 15 stores the user ID, the receipt locker number, and the storage date/time in the delivery management DB 20 as storage completion information.

When the storage completion information relating to storage in the receipt locker has been registered, the delivery procedure communication unit 14 sends to the user terminal 4 of the bidder R a notification of completion of storage in the receipt locker, and communicates to the user terminal 4 of the bidder R information used for pickup of the auction item from the receipt locker (S118). The information used for pickup includes the locker number, information about locking, and information about unlocking that have been communicated from the delivery person U-2.

When the delivery state management unit 15 has received from the user terminal 4 of the bidder R a notification of completion of pickup of the auction item from the receipt locker (S119), the delivery state management unit 15 stores the user ID, the receipt locker number, and the pickup date/time in the delivery management DB 20 as pickup completion information.

When receipt of the auction item has been completed, the delivery procedure communication unit 14 sends to the user terminal 3 of the seller S and to the user terminals 5 of the delivery persons U-1 and U-2 a receipt completion notification (S120).

In the delivery sequence described above, the delivery state management unit 15 is configured to allow the user terminals 3 to 5 to browse information about storage in the shipping locker by the seller S, information about completion of pickup and completion of storage by the delivery persons U-1 and U-2, and information about completion of pickup from the receipt locker by the bidder R. Accordingly, the users are able to monitor the delivery state of the auction item in real time and a person next involved is able to prepare for the next action without waiting for information to be communicated from the delivery procedure communication unit 14.

Next, when receipt of the auction item has been completed as described above, the reward giving unit 16 notifies the user terminals 5 of the delivery persons U-1 and U-2 of a bonus being given as a reward for the delivery (S121 and S122). When the reward giving unit 16 has received the user IDs and requests for acquiring the reward from the delivery persons U-1 and U-2 (S123 and S124), the reward giving unit 16 gives rewards to the delivery persons U-1 and U-2 (S125 and S126). A bonus, which is a reward, includes points, money, discount, and the like. In the case where delivery by a plurality of delivery persons is performed as in the embodiment, allocation of a reward will be computed in accordance with a specific rule separately created by an administrator. A specific rule is such that a reward is allocated in accordance with the delivery distance or a reward is allocated in accordance with the train fare incurred in the delivery, for example, however, the rule is not limited to the above described examples.

As described above, a user selected by means of recruitment is determined to be a delivery person and the delivery person is made to perform delivery between lockers by using lockers selected by the seller S and the bidder R respectively. Therefore, users are able to perform shipping, delivery, and receipt on any day and at any time the users like and have time, which is efficient. Particularly, a delivery person is able to perform delivery within an area between the stations to which the delivery person usually travels when commuting to/from work, school, or the like by using a day and time spent travelling in order to commute to/from work, school, or the like and therefore the delivery person does not use time to perform the delivery and does not bear costs.

A reward, such as points, is given to a delivery person, which will further increase the eagerness of the delivery person to buy, and furthermore will reduce the distribution costs, leading to a synergetic effect.

First Modification

The delivery sequence is not limited to that described above, and may be implemented by using a simpler delivery procedure. Processing performed in a simpler delivery procedure which is different from the processing described above will be described below.

When the delivery state management unit 15 has received from the user terminal 3 of the seller S a notification of completion of storage in a shipping locker including the user ID, the package ID, and the shipping locker number, the delivery state management unit 15 identifies the user ID of the bidder R and the receipt location (the station specified as the receipt location) on the basis of the package ID included in the notification, and stores the user ID and the information about the receipt location together with the package ID in the delivery management DB 20.

When the delivery person determination unit 13 has received from the user terminal 5 of a general user U an application made by inputting information about the stations at which the user gets on and off, as a query, the delivery person determination unit 13 searches the delivery management DB 20 for shipping lockers in which items are being stored among lockers located in the stations mentioned in the query, and communicates to the user terminal 5 a list of information (also including shipping deposit location information) about the items stored in the shipping lockers. When the delivery person determination unit 13 has been communicated from the user terminal 5 a selected item that the user desires to deliver, the delivery person determination unit 13 sets the user as a delivery person in accordance with a predetermined rule and notifies the user terminal 5 of the setting.

In a word, a delivery person is recruited after the seller S has stored an item in a shipping locker, and a list of shipping lockers corresponding to a query inputted by a delivery person is communicated so as to make the delivery person select an item that the delivery person desires to deliver, which is a difference from the embodiment described above.

Second Modification

The embodiment described above has been described while assuming a flow in which a coin-operated locker usually used as a locker apparatus is used, which is a locker used by inputting a password number.

However, as a locker apparatus placed in a train station, an electronic locker having a short-range communication unit mounted on the peripheral surface thereof which enables electronic exchange of information has been used currently, although such an electronic locker is not illustrated. The embodiment may also be implemented by using such an electronic locker apparatus on the basis of a similar technical idea. In this case, the user terminal is a portable terminal having a short-range communication function and a delivery sequence between the delivery management apparatus 1 and the user terminal is substantially the same as the delivery sequence described above. Therefore, description of the delivery sequence will be omitted.

As an electronic locker, a locker may be used which includes a touch panel used to display various types of information and to receive input, a communication device that performs short-range communication in order to exchange information with a portable terminal of a user, an electronic money reader that reads a prepaid-type electronic cash card, a debit card used for immediate deduction from a bank account, and the like, a coin drop device used to drop coins, and a code reader that reads a two-dimensional barcode, such as a QR code (registered trademark), and the like. As a short-range communication device, a device based on radio frequency identifier (RFID) or infrared communication may be used.

For example, in the user terminal 3 owned by the seller S, a dedicated utility program used for communication with an electronic locker is mounted. When the seller S holds the user terminal 3 over the communication unit of an electronic locker, the locker is unlocked. When the seller S puts an auction item in an electronic locker and closes the door, the electronic locker is locked. When the seller S holds the user terminal 3 over the communication unit, the electronic locker is firmly locked. In this case, information about the storage locker, such as the locker number, information used for locking and unlocking, and the lock date/time, is transmitted from the communication unit of the electronic locker to the user terminal 3. When the user terminal 3 has received the locker information from the communication unit of the electronic locker, the user terminal 3 transmits the user ID and the locker information to the delivery state management unit 15 of the delivery management apparatus 1.

The delivery state management unit 15 stores the user ID and the locker information in the delivery management DB 20.

When exchanging locker information between the electronic locker and the user terminal and exchanging information between the user terminal and the delivery management apparatus 1, the method described above is repeatedly performed. Therefore, description of such exchanges will be omitted.

In the case where electronic lockers are able to be connected to the network 6, the delivery management apparatus 1 is able to acquire information about the availability of electronic lockers. Therefore, it is also possible to perform high-quality delivery management by specifying a locker in which the seller S or the delivery person U is to store an item and by communicating, to the users concerned, information about the locker and information used to lock or unlock the locker.

In this case, the delivery procedure communication unit 14 communicates to the seller S information used for storage in the shipping locker, communicates to the delivery persons U-1 and U-2 information used for pickup from the shipping locker or from the relay locker and information used for storage in the relay locker or in the receipt locker, and communicates to the bidder R information used for pickup from the receipt locker. Note that, in the case where a touch panel is used, information used for storage and information used for pickup are password numbers or the like of the locker.

As a device used to perform open/close operations of an electronic locker, an integrated circuit (IC) card having a so-called stored fare function, which is a function of storing electronic money, may be used in addition to a portable phone, the IC card being issued by a card issuer.

In recent years, cards issued by train operators and having train pass functions or stored fare functions have been widely used. Such cards may be used in the embodiment in which a user holds this type of card over the electronic money reader of an electronic locker.

In the case of delivery of an auction item using a convenience store, an apparatus including a communication unit that has a function similar to that of an electronic locker is placed in a convenience store and information is exchanged in a similar manner to thereby enable delivery.

Third Modification

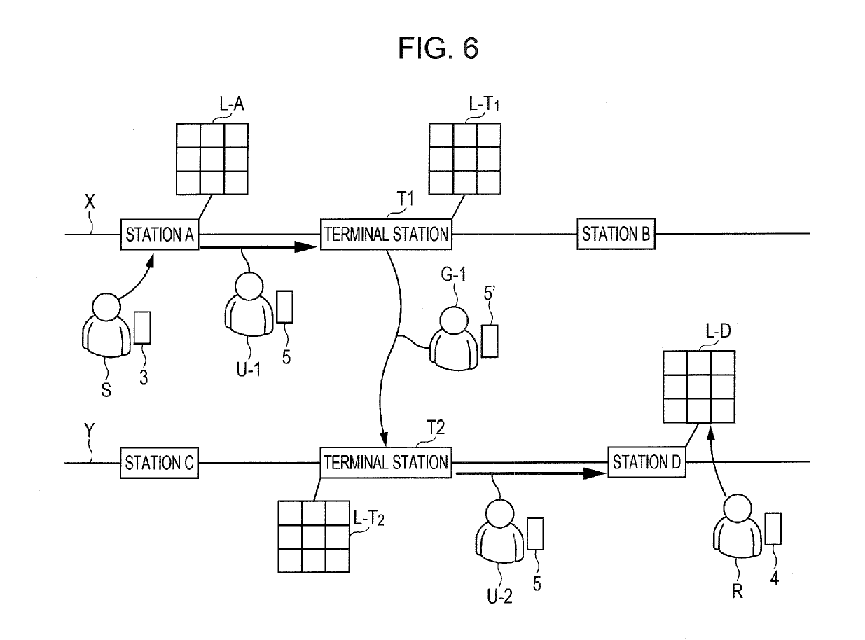

Next, FIG. 6 illustrates a delivery route used for delivery from the station A on the line X to the station D on the line Y. The delivery route illustrated in FIG. 6 is different from those illustrated in FIGS. 3 and 4 in that a station that serves as the contact point of the lines X and Y does not exist. That is, a case where it is not possible to perform delivery by only using trains is illustrated. Even in this case, delivery management may be implemented on the basis of the technical idea of the embodiment. The delivery procedure and exchange of delivery information are substantially the same as those described above and description thereof overlaps the description given above. Therefore, the delivery sequence relating to FIG. 6 will be omitted.

In a word, delivery management may be implemented by recruiting and determining a delivery person who is able to perform delivery between a terminal station T1 on the line X and a terminal station T2 on the line Y.

The delivery information reception unit 12 may receive information about a user who travels from the terminal station T1 to the terminal station T2 by bus, by car, by bicycle, on foot, or the like and the delivery person determination unit 13 may determine an appropriate delivery person. A delivery service provider G-1 having a user terminal 5′, the delivery service provider G-1 having been certified as a user of the delivery management apparatus 1, may be determined to be a delivery person handling delivery between the terminal stations. Exchange of information between the delivery management apparatus 1 and the user terminals 5 and 5′ of the users determined to be delivery persons is performed as described above and therefore description thereof will be omitted.

### CONCLUSION

As described above, the delivery management apparatus 1 of the embodiment of the present invention determines a user who has completed user registration to be a delivery person and makes the user perform delivery and therefore delivery costs may be substantially reduced. In some cases, it is possible to reduce the delivery costs to substantially zero and therefore delivery with the delivery management apparatus 1 is sufficiently competitive with a mail delivery service provider that has realized low delivery costs. Delivery is performed between lockers and therefore users are able to perform shipping, delivery, and receipt on any day and at any time the users like and have time, which is efficient. Furthermore, by reducing the delivery costs, the costs incurred by the seller S in putting an item up for auction are reduced and a user is able to buy an item at a low price, which may contribute to the development of both sales systems and distribution systems.

According to the embodiments of the present invention, an effective delivery management apparatus and a recording medium storing an effective delivery management control program may be provided with which delivery costs may be substantially reduced and a user is able to receive a delivery item on any day and at any time the user likes.

While the present invention has been described with reference to preferred embodiments of the present invention and specific examples, it is obvious that various modifications and changes may be made to such specific examples without departing from the broad spirit and scope of the present invention defined by the claims. That is, it should not be understood that the present invention is limited by the details of the specific examples or the drawings attached hereto. Accordingly, it is intended that elements in different embodiments may be combined as long as no contradiction arises, and various alternations and changes may be made within the scope of the spirit of the disclosed technique specified by the claims.

What is claimed is:

1. A delivery management apparatus comprising:
a delivery information reception unit that receives from a sender input of information about a shipping deposit location relating to a delivery item, and receives from a recipient input of information about a receipt location relating to the delivery item;
a delivery person determination unit that communicates at least the information about the shipping deposit location and the information about the receipt location to users in order to recruit a user who desires to perform delivery, and determines a delivery person from applicant users in accordance with a predetermined rule; and
a delivery procedure communication unit that at least communicates to the delivery person information used for pickup of the delivery item from the shipping deposit location or from a relay storage location in which another delivery person has stored the delivery item and information used for storage in the relay storage location or in the receipt location, and
communicates to the recipient information used for pickup of the delivery item from the receipt location in which the delivery person has stored the delivery item.

2. The delivery management apparatus according to claim 1, further comprising:
a delivery state management unit that
receives from the sender a notification of completion of storage of the delivery item in the shipping deposit location,
receives from the delivery person a notification of completion of pickup of the delivery item from the shipping deposit location or from the relay storage location,
receives from the delivery person a notification of completion of storage of the delivery item in the relay storage location or in the receipt location, and
receives from the recipient a notification of completion of pickup of the delivery item from the receipt location.

3. The delivery management apparatus according to claim 2, wherein
the delivery state management unit displays in a browsable manner
information about completion of storage of the delivery item in the shipping deposit location by the sender,
information about completion of pickup of the delivery item from the shipping deposit location or from the relay storage location by the delivery person,
information about completion of storage of the delivery item in the relay storage location or in the receipt location by the delivery person, and
information about completion of pickup of the delivery item from the receipt location by the recipient.

4. The delivery management apparatus according to claim 2, wherein
the delivery procedure communication unit notifies, upon receiving a notification of completion of storage of the delivery item, a person next involved of completion of the storage, and communicates to the person next involved information used for pickup of the delivery item from a storage location.

5. The delivery management apparatus according to claim 1, wherein
the delivery person determination unit recruits a delivery person by displaying to users who have completed user registration information about a shipping deposit location and information about a receipt location relating to an auction item, and determines a delivery person.

6. The delivery management apparatus according to claim 1, further comprising:
a reward giving unit that gives a bonus to the delivery person who has delivered the delivery item.

7. A non-transitory recording medium storing a delivery management control program that causes a computer to function as the units included in the delivery management apparatus according to claim 1.
